(19) United States
(12) Patent Application Publication
(10) Pub. No.: US 2019/0084776 A1
(43) Pub. Date: Mar. 21, 2019

(54) CONTAINER HANDLING MACHINE FOR HANDLING CONTAINERS, SUCH AS BEVERAGE BOTTLES OR CANS

(71) Applicants: Andreas FAHLDIECK, Idar-Oberstein (DE); Sebastian ECKES, Sprendlingen (DE)

(72) Inventors: Andreas FAHLDIECK, Idar-Oberstein (DE); Sebastian ECKES, Sprendlingen (DE)

(21) Appl. No.: 15/923,166

(22) Filed: Mar. 16, 2018

Related U.S. Application Data
(63) Continuation-in-part of application No. PCT/EP2016/070342, filed on Aug. 29, 2016.

(30) Foreign Application Priority Data
Sep. 17, 2015 (DE) 10 2015 115 729.2

(51) Int. Cl. B65G 47/90

(52) U.S. Cl. CPC B65G 47/90; B65G 2201/0252; B65G 2201/0244

(57) ABSTRACT

A container handling machine for handling containers, such as beverage bottles or cans. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2016/070342, filed on Aug. 29, 2016, which claims priority from Federal Republic of Germany Patent Application No. 10 2015 115 729.2, filed on Sep. 17, 2015. International Patent Application No. PCT/EP2016/070342 was pending as of the filing date of this application. The United States was an elected state in International Patent Application No. PCT/EP2016/070342.

### BACKGROUND

### 1. Technical Field

The present application relates to a container handling machine for handling containers, such as beverage bottles or cans.

### 2. Background Information

Background information is for informational purposes only and does not necessarily admit that subsequently mentioned information and publications are prior art.

Container handling machines, in many instances, include a transport element that is configured as a transport star and is driven in circulation about a vertical machine axis, which is provided at its circumference with container receivers, such as pocket-type container receivers. The container receivers form container arrangements, with which the containers, which are to be transported with the container handling machine, are in contact at least with a part of their circumference of the container casing surface and are supported in particular in the direction of rotation of the transport element, and against this direction of rotation.

Some container handling machines have container receivers that can be adjusted such as to match the containers with different container diameters, i.e., in particular, the effective distance interval between the container arrangements of each container receiver can be adjusted, and specifically in common in each case for all container receivers. With some container handling machines, this adjustability of the container receivers is achieved in that at least two carrier rings are provided at a base of the transport element, which can be driven about the vertical machine axis. The at least two carrier rings are arranged above one another or stacked in the direction of the machine axis and comprise, at their circumference in each case, a plurality of receivers in the form of transport pockets.

The at least two carrier rings can be rotated or pivoted relative to one another and relative to the base, in counter-direction about the machine axis. In one formation of this arrangement, the receivers, in the form of transport pockets of the at least two carrier rings, are arranged in each congruent in coverage, and therefore form a receiver for containers with the largest diameter to be transported. In other words, the transport pockets of one carrier ring overlap the transport pockets of another carrier ring to together define a single group of transport pockets. From this formation, in order to adjust to containers with smaller container diameters, the two carrier rings can be rotated in counter-direction, i.e., one clockwise and the other counterclockwise, and vice versa, about the machine axis in such a way that the receivers in the form of transport pockets only still partially cover one another. As a result, each pocket receiver of one carrier ring forms, with a pocket receiver of the other carrier ring, a container receiver which exhibits a reduced width in the direction of rotation of the transport element. The counter-direction rotation of the carrier rings is carried out by way of an adjustment mechanism, which adjustment mechanism, in some container handling machines, is in the form of or includes a toothed wheel or threaded spindle drives, which are relatively elaborate in design and thus may be difficult to access for cleaning or repair purposes.

Such container handling machines, including those with adjustable container receivers or receivers adjustable to different container diameters, generally serve to transport containers through a system, or are, for example, a constituent part of a larger container handling machine or a container handling complex for the filling of containers, a closing device for closing containers, or a machine for equipping the containers, such as for labelling and/or printing of containers, wherein the containers are then in each case held securely in the container receiver during the treatment.

### OBJECT OR OBJECTS

An object of the present application is to provide a container handling machine of which the container receivers can be adjusted in common in order to match containers with different diameters, and specifically with high operational reliability and simplified structural design, easier operation, and simpler access, in particular also with regard to the adjustment mechanism.

### SUMMARY

The object can be achieved in a container handling machine according to at least possible embodiment disclosed herein.

“Containers” in the meaning of the present application refer to cans and bottles, in each case made of metal, glass, and/or plastic, but also other packing devices, which are suitable for the filling of liquid or viscous products.

The expressions “essentially” or “approximately” in the meaning of the present application signify deviations from the respective exact value in each case by +/−10%, or by +/−5%, and/or deviations in the form of changes which are not of significance to the function.

Further embodiments, advantages, and possible applications of the embodiments are also derived from the following description of exemplary embodiments and from the figures.

Not represented or described in detail are stand surfaces or plates or container supports or container support structures, on which containers stand upright on their base side and/or gripper elements arranged in the neck or mouth areas of the containers in order to hold them or carry them. Such structures and devices are generally well known in the field of container handling and/or beverage bottling, and thus are not described in any detail herein. However, examples of such structures can possibly be found in the publications incorporated by reference herein.

In this situation, all the features described and/or represented in figures are in principle objects of the embodiments of the application, individually or in any desired combination, regardless of their inclusion in the claims or reference to them.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows a portion, in a perspective view, of a star-shaped transport element with adjustable container receivers according to one possible embodiment;

FIG. 2 shows a view from above of the embodiment of the transport element shown in FIGS. 1; and

FIGS. 3 and 4 show side views of the embodiment of the transport element shown in FIG. 1.

### DESCRIPTION OF EXEMPLIFICATION OR EXEMPLIFICATIONS

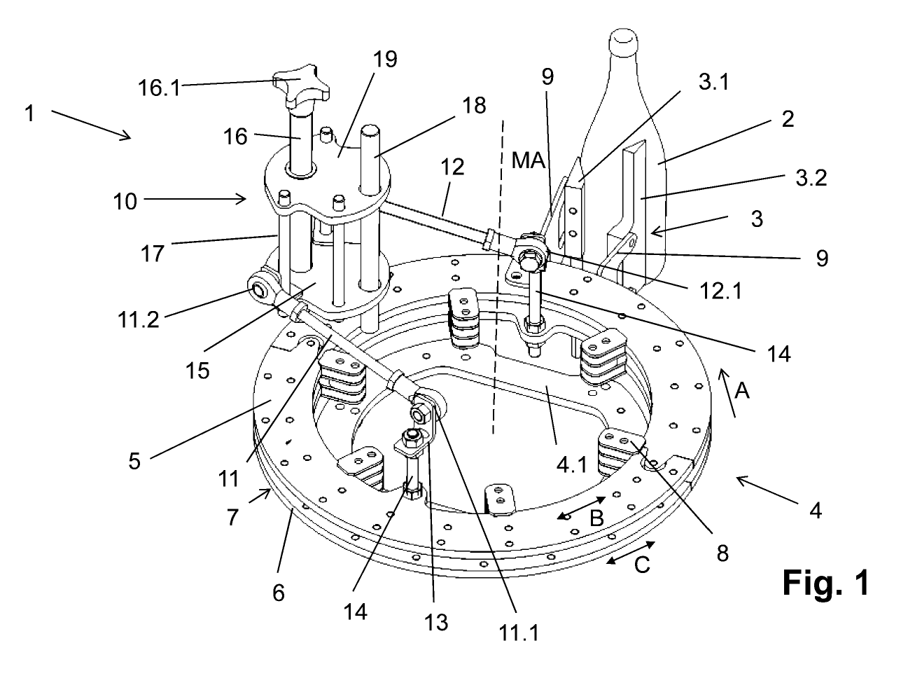

FIG. 1 shows a portion, in a perspective view, of a star-shaped transport element with adjustable container receivers, wherein, for the sake of simpler representation, only one of the container receivers and only one of the function elements required for the adjustment of the container receivers are represented. FIG. 1 shows a transport element 1, in the form of a transport star, of a container handling machine for the transporting of containers 2, which are represented as bottles but only by way of example and not restricted thereto. The transport element 1 of the container handling machine, which serves, for example, for the transporting of the containers 2 inside a container treatment system between devices or machines of this system, or is a part of a container treatment machine, can be driven in a well known manner in the field of container handling or beverage bottling, on a machine frame, not represented, such as to circulate about a vertical machine axis MA (arrow or direction of rotation A).

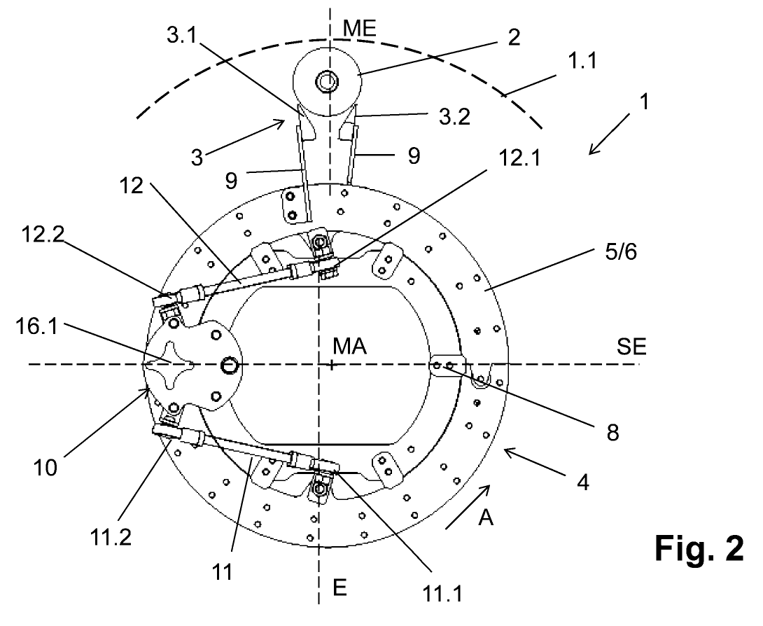

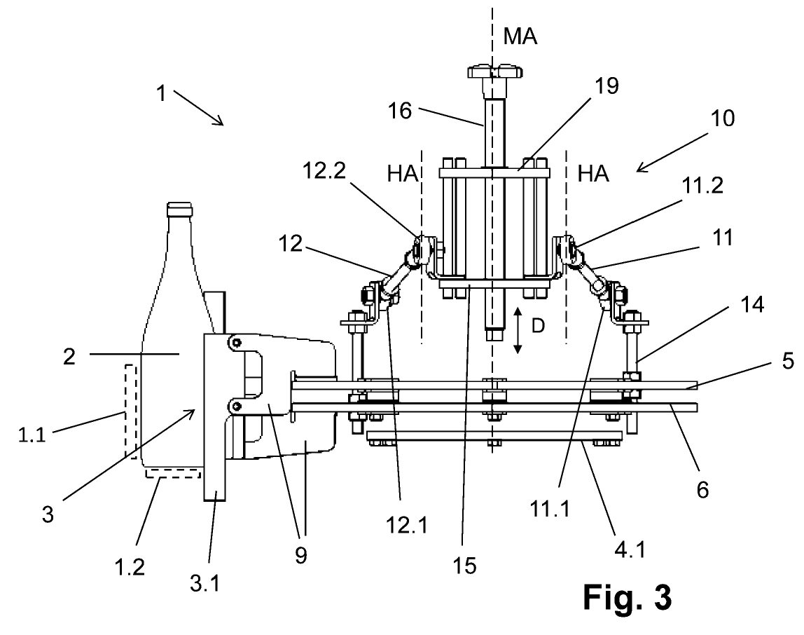

At the circumference, the transport element 1 has a plurality of pocket-like container receivers 3, offset against one another at the same or similar angle distances or division intervals about the machine axis MA, of which only one container receiver 3 is shown in the figures. Each container receiver 3 is formed from two container contact elements 3.1 and 3.2, following one another in the direction of rotation A and, in the embodiment represented, configured in the form of a strip, against which the containers 2 are in contact with their casing surfaces. In order to hold the containers 2 in the container receivers, an outside container guide is provided in the form of a rail or plate or wall or other suitable guide structure suitable for guiding containers, which is stationary or does not circulate with the transport element 1, indicated in FIGS. 2 and 3 by the broken line 1.1. Also provided is a guide element 1.2 or support element or plate or other suitable guide structure, which is stationary or does not circulate with the transport element 1 and indicated in FIG. 3 by broken lines. The guide element 1.2 surrounds the machine axis MA in ring fashion, at least on one angle range of the rotational movement of the rotational movement of the transport element 1, on which guide element 1.2 the transport of the containers 2 takes place and on which the containers 2 stand upright on their bases.

In order to adapt the container receivers 3 to containers 2 with different container diameters, the container receivers are adjustable, for which purpose the two container contact elements 3.1 and 3.2 are movable in opposite directions in the circumferential direction of the handling element 1. This adjustment takes place in common or simultaneously or essentially simultaneously for all the container receivers 3. For this purpose, in the embodiment represented, adjustment or support or carrier rings 5 and 6 are provided, which are located above a base ring 4.1. The base ring 4.1 is a part of a rotor 4 of the transport element, and is driven such as to circulate about a machine axis MA or central axis or rotational axis of the rotor 4. The carrier rings 5 and 6 likewise concentrically surround the machine axis MA, which in the embodiment represented consist identically of or comprise, in each case, two ring segments adjacent to and connected to one another. Just as with the base ring 4.1, the carrier rings 5 and 6 are oriented with their ring planes perpendicular or essentially perpendicular or substantially perpendicular to the machine axis MA. ME designates the vertical mid-plane of the respective container receiver 3, surrounding the machine axis MA, with the contact elements 3.1 and 3.2 of each container receiver being arranged on both sides of this mid-plane and at the same or similar distance interval from the mid-plane.

The two carrier rings 5 and 6 are arranged coaxially, but are, for example, spaced somewhat apart from one another in the direction of the machine axis MA. By way of retaining and guiding elements 8, the two carrier rings 5 and 6 are guided at the rotor 4 and the base ring 4.1, and can rotate by an angle amount necessary for the adjustment of the container receivers 3 relative to one another about the machine axis MA, as indicated in FIG. 1 by the double arrows B and C. In addition, the carrier ring arrangement 7 formed by the two carrier rings 5 and 6 can also be rotated opposite the base ring 4.1 about the machine axis MA by the angle amount necessary for the adjustment of the container receivers 3. For the sake of easier overview, the further connection elements and/or guide elements and further elements of the rotor 4 of the transport element 1, driven such as to circulate about the machine axis MA, are not represented.

The contact elements 3.1 of the container receivers 3 are secured to the carrier ring 5 in each case by a carrier 9, manufactured for example from flat material by punching and bending, and located radially or essentially radially spaced above the carrier ring arrangement 7. The contact elements 3.2 are secured to the carrier ring 6 in each case by means of a further carrier 9, which is likewise located radially or essentially radially above the carrier ring arrangement 7. By the rotation of the carrier rings 5 and 6 relative to one another, the contact elements 3.1 and 3.2 of all the container receivers 3 are moved onto or into one another or apart from one another, and specifically depending on the direction of rotation. The opposed rotational movement of the carrier rings 5 and 6 takes place in this situation by the same angle amount in each case, such that the mid-plane ME of each container receiver 3 retains its position despite the adjustment.

The opposed adjustment movement or rotation of the carrier rings 5 and 6 takes place in the embodiment shown by an adjustment mechanism 10, and is executed by way of a first coupling element in the form of a rod 11 on the upper carrier ring 5, and by way of a second coupling in the form of a rod 12 on the lower carrier ring 6, with a tangential drawing or pushing force. In the embodiment represented, the rods 11 and 12 have the same or similar length. For this purpose, the end 11.1 of the rod 11 is connected by a ball joint to an angle element 13, which is connected by way of a stay bolt 14 or similar connecting structure, parallel or essentially parallel or substantially parallel to the machine axis MA, but spaced radially at a distance from it, to a projection or rounded tab or protrusion, formed on the inner side of the carrier ring 5. In the same way, the one end 12.1 of the rod 12 is connected by a ball joint to an angle element 13, which in turn is connected by the stay bolt 14 to another projection projecting over the inside of the carrier ring 6. The stay bolts 14 in this situation form in each case the contact or effect area of the rod 11 or 12 respectively on the carrier ring 5 or 6 respectively. The ends 11.1 and 12.1 are located in the direction of the machine axis MA at a distance above the end of the carrier ring 5, and specifically, in the embodiment represented, at the same distance interval from this plane.

The adjustment mechanism 10 comprises a lifting element 15, which in the embodiment represented is configured as a plate, which plate is oriented with its surface sides parallel to the planes of the carrier rings 5 and 6. The carrier rings 5 and 6 can be adjusted perpendicular to these surface sides by an adjustment or lifting drive element in the form of a threaded spindle 16, and specifically in an axial direction or adjustment direction, which is arranged in a common plane with the machine axis, and, in the embodiment represented, is oriented parallel or essentially parallel to the machine axis MA and therefore perpendicular to the surface sides of the plate forming the lifting element 15.

As represented, the adjustment mechanism 10 is offset radially with respect to the machine axis MA. In order to guide the lifting element 15, rod-like guide elements 17 and 18 are provided, which extend with their upper end into a carrier plate 19 arranged above the lifting element 15 and are secured there. The threaded spindle 16 is also guided through the carrier plate 19, such that this threaded spindle 16, arranged with its axis parallel or essentially parallel to the machine axis MA, projects with its upper end, comprising a handle 16.1, over the upper side of the carrier plate 19. By way of the threaded spindle 16, which is mounted, for example, as rotatable but not axially displaceable in the carrier plate 19, and engages with its outer thread into an inner thread of the lifting element 15. The lifting element 15 can therefore be moved in a vertical direction manually by a predetermined adjustment lift distance between a lower initial position and an upper end position. Secured to the lifting element 15, in each case by means of ball joints, are the other ends 11.2 and 12.2 of the rods 11 and 12, such that these ends are moved during the adjustment lift in each case in a lifting axis HA, which is oriented parallel or essentially parallel to the machine axis MA and spaced radially at a distance from it.

The arrangement is in this situation further disposed such that, in every position of the lifting element 15, the longitudinal extensions of the rods 11 and 12 enclose an angle with the plane intersecting the machine axis MA perpendicularly, such as an angle of less than 90 degrees, or possibly less than 45 degrees. In another embodiment of the present application, in which, for example, the carrier rings 5 and/or 6 exhibit very large diameters, the angle can also be greater than 90 degrees, with the angle then being, for example, less than or equal to degrees.

With the embodiment represented, the ends 11.2 and 12.2 of the rods 11 and 12, in each lifting position of the lifting element 15, are arranged at a common height level above the common height level of the ends 11.1 and 12.1. The arrangement is also disposed in such a way that, in a view from above onto the transport element 1, the rods 11 and 12 are arranged on different sides of a mid-plane or plane of symmetry SE, enclosing the machine axis MA, and specifically mirror-symmetrical to this plane. The areas on which the rods 11 and 12 take effect on or are operatively connected to the respective carrier rings 5 and 6 respectively exhibit a greater mutual distance interval from one another than the ends 11.2 and 12.2 connected to the lifting element 15. In other words, as viewed from above, such as in FIG. 2, the distance between the ends 11.1 and 12.1 is greater than the distance between the ends 11.2 and 12.2. The two rods 11 and 12 are therefore arranged such that their longitudinal extensions or longitudinal dimensions lie in planes or vertical planes that are arranged parallel to the machine axis MA, are perpendicular to the ring planes of the carrier rings 5 and 6, and intersect at an acute angle that opens in the direction of the machine axis MA, and, respectively, the projections of the rods 11 and 12 on ring planes of the carrier rings 5 and 6 form such an angle.

Additionally, the areas on which the rods 11 and 12, or their ends 11.1 and 12.1 respectively, take effect are arranged, in at least one possible embodiment, though not necessarily, in a notional plane E, oriented perpendicular to the ring planes of the carrier rings 5 and 6, the distance interval of which from the lifting axes HA is, for example, somewhat less than the distance interval exhibited by the machine axis MA from the lifting axes.

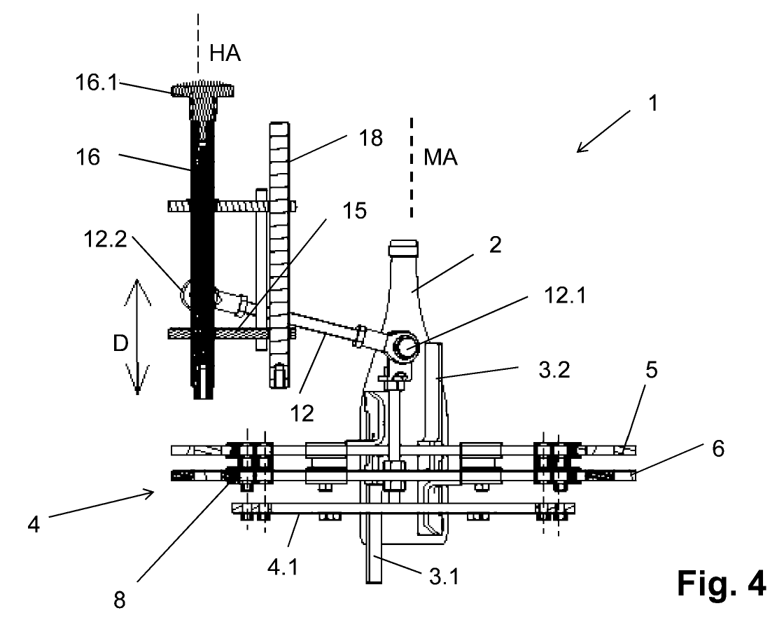

The conversion of the lifting movement (double arrow D in FIG. 4) of the lifting element 15 into the rotational or swivelling movement of the carrier rings 5 and 6 therefore takes place in such a way that, at the lifting movement of the lifting element 15, the ends 11.2 and 12.2 of the rods 11 and 12 move exclusively in the lifting axis HA. This lifting movement thereby causes an enlargement or reduction respectively of the inclination angles of the rods 11 and 12, resulting in a reduction or increase respectively of the distance interval between the respective lifting axis HA and the respective end 11.1 or 12.1. As a result, a drawing or thrust force is exerted by way of the rods 11 and 12 onto the carrier rings 5 and 6, of which the components running tangentially to the carrier rings 5 and 6 cause the counter-directional rotation of the carrier rings 5 and 6 about the machine axis MA in one or the other direction, and therefore the counter-directional movement of the contact elements 3.1 and 3.2 of all the container receivers 3 for adjustment to different container diameters.

In other words, according to one possible embodiment, the carrier rings 5 and 6 are arranged parallel or essentially parallel to the horizontal dimension, i.e., perpendicular to the vertical dimension. As a result, the carrier ring 5 is an upper carrier ring 5 disposed above or over or on top of the lower carrier ring 6. In this embodiment, as the lifting element 15 is moved vertically upwardly away from the upper carrier ring 5, the rod ends 11.2 and 12.2 are also moved vertically upwardly away from the upper carrier ring 5. When the rod ends 11.2 and 12.2 are moved vertically upwardly away from the upper carrier ring 5, the rod ends 11.1 and 12.1 connected to the carrier rings 5 and 6 are pulled toward the adjustment mechanism 10 along a curved or circular path. As a result, the upper carrier ring 5, as viewed from above, is rotated clockwise, and the lower carrier ring 6 is rotated counter-clockwise. These opposing rotational movements cause the contact elements 3.1 and 3.2 to be moved closer together to thereby make the container receiver or pocket 3 smaller. Conversely, as the lifting element 15 is moved vertically downwardly toward the upper carrier ring 5, the rod ends 11.2 and 12.2 are also moved vertically downwardly toward the upper carrier ring 5. When the rod ends 11.2 and 12.2 are moved vertically downwardly toward the upper carrier ring 5, the rod ends 11.1 and 12.1 connected to the carrier rings 5 and 6 are pushed away from the adjustment mechanism 10 along a curved or circular path. As a result, the upper carrier ring 5, as viewed from above, is rotated counter-clockwise, and the lower carrier ring 6 is rotated clockwise. These opposing rotational movements cause the contact elements 3.1 and 3.2 to be moved away from one another to thereby make the container receiver or pocket 3 larger. In this manner, the size of the container receivers or pockets 3 can be adjusted in size by the adjustment mechanism 10.

It is understood that the adjustment mechanism 10 and the rod-like carrier elements 17 and 18, and therefore also the carrier plate 19, are likewise connected in a suitable manner to the base ring 4.1 and/or to another function element of the star-like transport element 1, e.g., with its rotor 4.

As can be seen in FIG. 3, the contact elements 3.1 and 3.2 have the same or similar profile or shape or design. In the embodiment shown in FIG. 3, the contact element 3.1 is mounted so that the elongated portion is extending downwardly, whereas the contact element 3.2, which is mostly obscured in FIG. 3 by the container 2, is mounted so that the elongated portion is extending upwardly. This configuration allows for production or manufacture of a single type of contact element for use in either position to provide sufficient grasping or holding or guiding of the containers 2, rather than requiring production or manufacture of two different types of contact elements, which would be less advantageous with respect to production or manufacturing costs.

By the use of the threaded spindle 16, a secure setting, or essentially secure setting, or substantially secure setting of the respective adjustment of the lifting element 15, and therefore of the container receivers 3 is ensured or promoted. In addition to this, by way of the threaded spindle 16 an additional guide is attained for the lifting element 15. Further advantages of the container handling machine 1, and in this context in particular of the adjustment mechanism, are, among others:
very simple and compact design structure, therefore also usable for smaller part circles or transport elements with reduced diameters;
reliable function and simple operation;
easy adjustment of the container receivers 3 by way of a plurality of carrier rings;
simplified cleaning; and
highly robust and/or durable, including in respect of glass shards and/or glass splinters, which may damage the machine parts or components upon breakage of a glass container.

It has been assumed heretofore that the adjustment of the container receivers 3 is carried out manually by means of a lifting element configured as a threaded spindle. A motorized adjustment of the container receivers 3 by way of the rods 11 and 12 is of course also possible, for example by providing a motorized lifting drive instead of the threaded spindle 16, such as a motorized linear drive or spindle drive.

The base ring 4.1 is a part of a rotor 4, not otherwise further represented and driven such as to circulate about the machine axis MA, to which the carrier rings 5 and 6 are held such as to pivot or rotate about the machine axis MA with the aid of guide elements, in the manner described heretofore.

One feature or aspect of an exemplification is believed at the time of the filing of this patent application to possibly reside broadly in a container handling machine with a transport element 1 driven such as to circulate about a vertical machine axis and with a plurality of pocket-like container receivers provided at the circumference of the transport element, which in each case comprise at least two contact elements 3.1, 3.2 for the containers 2, offset relative to each other in the direction of rotation of the transport element 1, with at least one adjustment or carrier ring 5, formed or provided at which are first contact elements 3.1 of the container receivers 3, with at least one adjustment or carrier ring 6, provided at which are the second contact elements 3.2 of the container receivers 3, and with an adjustment mechanism 10 for the rotation in the opposite direction of the carrier rings 5, 6, for the setting and adjustment of the container receivers 3 to different container diameters, wherein the adjustment mechanism 10 comprises at least one lifting element 15, which can be adjusted by a lifting drive in the adjustment axis, which is arranged in a common plane with the machine axis MA, and that the at least one lifting element 15 takes effect on each carrier ring 5, 6 such as to pivot this carrier ring about the machine axis MA by means in each case of a coupling element 11, 12, and specifically onto different sides of a plane SE enclosing the machine axis MA and oriented perpendicular to the planes of the carrier rings 5, 6.

Another feature or aspect of an exemplification is believed at the time of the filing of this patent application to possibly reside broadly in the container handling machine, wherein the adjustment axis is oriented parallel or essentially parallel to the machine axis MA.

Yet another feature or aspect of an exemplification is believed at the time of the filing of this patent application to possibly reside broadly in the container handling machine, wherein the coupling elements 11, 12 are arranged and/or configured such as to convert the lifting movement D of the lifting element 15 into a drawing or thrusting movement taking effect tangentially onto the carrier rings 5, 6.

Still another feature or aspect of an exemplification is believed at the time of the filing of this patent application to possibly reside broadly in the container handling machine, wherein the coupling elements are rods 11, 12, which take effect at a first end 11.1, 12.1 in each case by way of a joint, preferably by a ball joint, onto a carrier ring 5, 6.

A further feature or aspect of an exemplification is believed at the time of the filing of this patent application to possibly reside broadly in the container handling machine, wherein the coupling elements 11, 12 are inclined with their longitudinal extension opposite a plane intersecting the machine axis MA perpendicularly, preferably in that first ends 11.1, 12.1 of the coupling elements 11, 12, taking effect onto the carrier rings 5, 6, lie closer to this plane than second ends 11.2, 12.2 connected to the lifting element 15.

Another feature or aspect of an exemplification is believed at the time of the filing of this patent application to possibly reside broadly in the container handling machine, wherein the adjustment mechanism 10 and its lifting element 15 are provided at a radial distance interval from the machine axis MA, preferably by way of the carrier ring arrangement formed by the carrier rings 5, 6 and, for example, inside the movement path of the container receivers 3.

Yet another feature or aspect of an exemplification is believed at the time of the filing of this patent application to possibly reside broadly in the container handling machine, wherein the container handling machine comprises a lifting drive for the lifting element 15, whereby the lifting drive is, for example, a threaded spindle 16 or a motorised lifting drive, for example in the form of a motorised linear drive or spindle drive.

Still another feature or aspect of an exemplification is believed at the time of the filing of this patent application to possibly reside broadly in the container handling machine, wherein the container receivers 3.1, 3.2 are formed from contact elements, for example from strip-like contact elements, which are oriented with their longitudinal extension parallel or essentially parallel to the machine axis MA.

A further feature or aspect of an exemplification is believed at the time of the filing of this patent application to possibly reside broadly in the container handling machine, wherein a projection of the coupling elements 11, 12 onto the plane of the carrier rings 5, 6 is oriented parallel or substantially parallel to a tangent to the area of the respective carrier ring 5, 6 on which the coupling element 11, 12 allocated to this carrier ring 5, 6 takes effect on the carrier ring 5, 6.

Another feature or aspect of an exemplification is believed at the time of the filing of this patent application to possibly reside broadly in the container handling machine, wherein the carrier rings 5, 6 are held by guides or guiding elements 8 on a base 4 of the transport element 1, driven such as to circulate about the machine axis MA.

Yet another feature or aspect of an exemplification is believed at the time of the filing of this patent application to possibly reside broadly in the container handling machine, wherein the coupling elements 11, 12 are arranged with their longitudinal extensions in planes oriented perpendicular to the plane of the carrier rings 5, 6, which enclose an angle of less than 45 degrees to one another, opening towards the machine axis MA.

Still another feature or aspect of an exemplification is believed at the time of the filing of this patent application to possibly reside broadly in the container handling machine, wherein the coupling elements 11, 12 are arranged with their longitudinal extensions in planes oriented perpendicular to the plane of the carrier rings 5, 6 which enclose an angle of less than degrees to one another, opening towards the machine axis MA.

A further feature or aspect of an exemplification is believed at the time of the filing of this patent application to possibly reside broadly in the container handling machine, wherein the coupling elements 11, 12 and their ends 11.1, 12.1; 11.2, 12.2 are arranged mirror-symmetrically to a plane of symmetry SE enclosing the machine axis MA.

One feature or aspect of an exemplification is believed at the time of the filing of this patent application to possibly reside broadly in a container handling arrangement for handling containers, such as bottles, cans, and other similar containers, comprising: a transport element being configured to be rotated about a vertical axis of rotation; a plurality of container receivers being disposed about the perimeter of said transport element; each container receiver comprising a first contact element and a second contact element; said transport element comprising a first carrier ring and a second carrier ring; said first contact element being disposed on said first carrier ring, and said second contact element being disposed on said second carrier ring; an adjustment mechanism being operatively connected to said carrier rings to rotate said carrier rings; said adjustment mechanism comprising a lifting element; a first connecting arrangement being configured and disposed to connect said lifting element to said first carrier ring; a second connecting arrangement being configured and disposed to connect said lifting element to said second carrier ring; said adjustment mechanism being configured to rotate said first carrier ring and said second carrier ring in opposite directions of rotation with respect to one another to thereby adjust the space between said first contact element and said second contact element, and thus increase or decrease the size of each of said container receivers to permit handling of containers of different diameters; said adjustment mechanism comprising a lifting drive configured to adjust the position of said lifting element along an adjustment axis, which adjustment axis defines a vertical plane with said vertical axis of rotation of said transport element that is perpendicular to the surfaces of said first and second carrier rings; and said first connecting arrangement being operatively connected to said first carrier ring on one side of the vertical plane, and said second connecting arrangement being operatively connected to said second carrier ring on the other side of the vertical plane.

Another feature or aspect of an exemplification is believed at the time of the filing of this patent application to possibly reside broadly in the container handling arrangement, wherein the adjustment axis is oriented parallel or essentially parallel to the vertical axis of rotation.

Yet another feature or aspect of an exemplification is believed at the time of the filing of this patent application to possibly reside broadly in the container handling arrangement, wherein said first and second connecting arrangements are configured and disposed to convert the lifting movement of said lifting element into a drawing or thrusting movement that takes effect tangentially on said first and second carrier rings.

Still another feature or aspect of an exemplification is believed at the time of the filing of this patent application to possibly reside broadly in the container handling arrangement, wherein: said first connecting arrangement comprises a first rod, a first end portion operatively connected to said first carrier ring, and a second end portion operatively connected to said lifting element; said first end portion of said first connecting arrangement comprises a connecting joint or a ball joint; said second connecting arrangement comprises a second rod, a first end portion operatively connected to said second carrier ring, and a second end portion operatively connected to said lifting element; and said first end portion of said second connecting arrangement comprises a connecting joint or a ball joint.

A further feature or aspect of an exemplification is believed at the time of the filing of this patent application to possibly reside broadly in the container handling arrangement, wherein said first and second connecting arrangements are inclined such that said first end portions are disposed closer, in a vertical direction, to said first and second carrier rings than said second end portions.

Another feature or aspect of an exemplification is believed at the time of the filing of this patent application to possibly reside broadly in the container handling arrangement, wherein said adjustment mechanism and said lifting element are disposed at a distance from the vertical axis of rotation at a position that is above or overlapping or partially overlapping said carrier rings and is inside the movement path of said container receivers.

Yet another feature or aspect of an exemplification is believed at the time of the filing of this patent application to possibly reside broadly in the container handling arrangement, wherein: said at least one lifting element comprises a lifting drive; and said lifting drive comprises a threaded spindle drive, a motorized lifting drive, a motorized linear drive, or a motorized spindle drive.

Still another feature or aspect of an exemplification is believed at the time of the filing of this patent application to possibly reside broadly in the container handling arrangement, wherein said contact elements comprise elongated, strip-like contact elements that are disposed such that their longitudinal extension is parallel or essentially parallel to the vertical axis of rotation.

A further feature or aspect of an exemplification is believed at the time of the filing of this patent application to possibly reside broadly in the container handling arrangement, wherein: said first carrier ring comprises a curved or rounded first projection at which said first connecting arrangement is operatively connected; said first connecting arrangement is oriented tangentially or essentially tangentially to said first projection, or parallel or essentially parallel to a tangent of said first projection; said second carrier ring comprises a curved or rounded second projection at which said second connecting arrangement is operatively connected; and said second connecting arrangement is oriented tangentially or essentially tangentially to said second projection, or parallel or essentially parallel to a tangent of said second projection.

Another feature or aspect of an exemplification is believed at the time of the filing of this patent application to possibly reside broadly in the container handling arrangement, wherein: said transport element comprises a base support; said container handling arrangement comprises a plurality of guides or guide elements connected to said base support; and said guides or guide elements are configured and disposed to support and hold said carrier rings, and are configured to permit rotation of said carrier rings.

Yet another feature or aspect of an exemplification is believed at the time of the filing of this patent application to possibly reside broadly in the container handling arrangement, wherein: said first rod of said first connecting arrangement lies in a first plane perpendicular to the surface of said first carrier ring; said second rod of said second connecting arrangement lies in a second plane perpendicular to the surface of said first carrier ring; the first and second planes, and thus the first and second rods lying therein, together define an angle that is open towards the vertical axis of rotation, and which angle is one of (A) and (B): (A) less than 45 degrees; and (B) less than 180 degrees.

Still another feature or aspect of an exemplification is believed at the time of the filing of this patent application to possibly reside broadly in the container handling arrangement, wherein the vertical plane defined by said adjustment axis and said vertical axis of rotation is a plane of symmetry, and said first and second connecting arrangements are arranged mirror-symmetrically with respect to the plane of symmetry.

A further feature or aspect of an exemplification is believed at the time of the filing of this patent application to possibly reside broadly in the container handling arrangement, wherein said lifting element is disposed offset from and not coaxial with said vertical axis of rotation.

Another feature or aspect of an exemplification is believed at the time of the filing of this patent application to possibly reside broadly in the container handling arrangement, wherein said lifting element is disposed above a portion of said first carrier ring adjacent an outer edge of said carrier ring.

Yet another feature or aspect of an exemplification is believed at the time of the filing of this patent application to possibly reside broadly in the container handling arrangement, wherein: said first connecting arrangement comprises a first rod, a first end portion operatively connected to said first carrier ring, and a second end portion operatively connected to said lifting element; said first end portion of said first connecting arrangement comprises a ball joint; said second connecting arrangement comprises a second rod, a first end portion operatively connected to said second carrier ring, and a second end portion operatively connected to said lifting element; and said first end portion of said second connecting arrangement comprises a ball joint.

Still another feature or aspect of an exemplification is believed at the time of the filing of this patent application to possibly reside broadly in the container handling arrangement, wherein said lifting element is configured to be adjusted to move said first end portions of said first and second connecting arrangements along a rounded or circular path, and thereby move said first and second carrier rings.

A further feature or aspect of an exemplification is believed at the time of the filing of this patent application to possibly reside broadly in the container handling arrangement, wherein said lifting element is configured to be adjusted to move said first end portions closer to and further away from said lifting element along the rounded or circular path.

Another feature or aspect of an exemplification is believed at the time of the filing of this patent application to possibly reside broadly in the container handling arrangement, wherein: each of said first and second carrier rings comprises a projection disposed to project inwardly beyond the inner diameter of each of said first and second carrier rings; and said first and second connecting arrangements are operatively connected to said first and second carrier rings at said projections.

Yet another feature or aspect of an exemplification is believed at the time of the filing of this patent application to possibly reside broadly in the container handling arrangement, wherein each of said first end portions is disposed above a corresponding one of said projections, and is connected thereto by a substantially vertically-oriented elongated connecting structure.

Still another feature or aspect of an exemplification is believed at the time of the filing of this patent application to possibly reside broadly in the container handling arrangement, wherein said contact elements comprise elongated, strip-like contact elements that are disposed such that their longitudinal extension is parallel or essentially parallel to the vertical axis of rotation.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

Some examples of container handling machines having adjustable container receivers, and/or components or parts thereof, that may possibly be utilized or adapted for use in at least one possible exemplification may possibly be found in the following patent publications, which are incorporated by reference herein: DE 694 05 650 T2 and EP 2 447 A1.

All of the patents, patent applications, patent publications, and other documents, except for the exceptions indicated herein, which were cited in the International Search Report dated Dec. 1, 2016, and/or cited elsewhere, as well as the International Search Report document itself, are hereby incorporated by reference as if set forth in their entirety herein except for the exceptions indicated herein, as follows: DE 100 50 084 A1, WO 2015/082381 A2, EP 0256 332 A2, FR 2 682 093 A1, US 2011/138613 A1, and US 2003/106779 A1.

All of the patents, patent applications, patent publications, and other documents, except for the exceptions indicated herein, which were cited in the German office action dated May 24, 2016, and/or cited elsewhere, as well as the German office action document itself, are hereby incorporated by reference as if set forth in their entirety herein except for the exceptions indicated herein, as follows: 10 2013 206 835 A1 and DE 100 50 084 A1. International Patent Application No. PCT/EP2016/070342, filed on Aug. 29, 2016, which claims priority from Federal Republic of Germany Patent Application No. 102015115729.2, filed on Sep. 17, 2015

The corresponding foreign and international patent publication applications, namely, Federal Republic of Germany Patent Application No. 10 2015 115 729.2, filed on Sep. 17, 2015, having inventors Andreas FAHLDIECK and Sebastian ECKES, and DE-OS 10 2015 115 729.2 and DE-PS 10 2015 115 729.2, and International Application No. PCT/EP2016/070342, filed on Aug. 29, 2016, having WIPO Publication No. WO2017/045906 A1 and inventors Andreas FAHLDIECK and Sebastian ECKES, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2016/070342 and Federal Republic of Germany Patent Application No. 10 2015 115 729.2, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2016/070342 and Federal Republic of Germany Patent Application No. 10 2015 115 729.2 from which this patent application claims priority which do not have to do with the correction of the translation in this patent application are not to be included in this patent application in the incorporation by reference.

Any statements about admissions of prior art in the original foreign patent applications PCT/EP2016/070342 and Federal Republic of Germany Patent Application No. 10 2015 115 729.2 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### AT LEAST PARTIAL LIST OF REFERENCE NUMERALS

1 Star-like transport element
1.1, 1.2 Container guide
2 Container
3 Container receiver
3.1, 3.2 Container contact element or container support element
4 Rotor
4.1 Base ring
5, 6 Carrier ring or carrier ring
7 Carrier ring arrangement
8 Retaining and guiding element
9 Carrier
10 Adjustment mechanism
11, 12 Rod
11.1, 12.1 Rod end
11.2, 12.2 Rod end
13 Angle element
14 Stay bolt
15 Lifting element
16 Threaded spindle
16.1 Handle
17, 18 Guide element or guide rod
19 Carrier plate
A Direction of rotation of the star-like transport element
B, C Rotational adjustment of the carrier ring 5 or 6 respectively
D Lifting movement of the lifting element 15
E Plane
MA Machine axis
HA Lifting axis of the lifting element 15
ME Mid-plane of the container receivers 3
SE Plane of symmetry

What is calimed is:

1. A container handling arrangement for handling containers, such as bottles, cans, and other similar containers, comprising:
a transport element being configured to be rotated about a vertical axis of rotation;
a plurality of container receivers being disposed about the perimeter of said transport element;
each container receiver comprising a first contact element and a second contact element;
said transport element comprising a first carrier ring and a second carrier ring;
said first contact element being disposed on said first carrier ring, and said second contact element being disposed on said second carrier ring;
an adjustment mechanism being operatively connected to said carrier rings to rotate said carrier rings;
said adjustment mechanism comprising a lifting element;
a first connecting arrangement being configured and disposed to connect said lifting element to said first carrier ring;
a second connecting arrangement being configured and disposed to connect said lifting element to said second carrier ring;
said adjustment mechanism being configured to rotate said first carrier ring and said second carrier ring in opposite directions of rotation with respect to one another to thereby adjust the space between said first contact element and said second contact element, and thus increase or decrease the size of each of said container receivers to permit handling of containers of different diameters;
said adjustment mechanism comprising a lifting drive configured to adjust the position of said lifting element along an adjustment axis, which adjustment axis defines a vertical plane with said vertical axis of rotation of said transport element that is perpendicular to the surfaces of said first and second carrier rings; and
said first connecting arrangement being operatively connected to said first carrier ring on one side of the vertical plane, and said second connecting arrangement being operatively connected to said second carrier ring on the other side of the vertical plane.

2. The container handling arrangement according to claim 1, wherein the adjustment axis is oriented parallel or essentially parallel to the vertical axis of rotation.

3. The container handling arrangement according to claim 2, wherein said first and second connecting arrangements are configured and disposed to convert the lifting movement of said lifting element into a drawing or thrusting movement that takes effect tangentially on said first and second carrier rings.

4. The container handling arrangement according to claim 3, wherein:
said first connecting arrangement comprises a first rod, a first end portion operatively connected to said first carrier ring, and a second end portion operatively connected to said lifting element;
said first end portion of said first connecting arrangement comprises a connecting joint or a ball joint;
said second connecting arrangement comprises a second rod, a first end portion operatively connected to said second carrier ring, and a second end portion operatively connected to said lifting element; and
said first end portion of said second connecting arrangement comprises a connecting joint or a ball joint.

5. The container handling arrangement according to claim 4, wherein said first and second connecting arrangements are inclined such that said first end portions are disposed closer, in a vertical direction, to said first and second carrier rings than said second end portions.

6. The container handling arrangement according to claim 5, wherein said adjustment mechanism and said lifting element are disposed at a distance from the vertical axis of rotation at a position that is above or overlapping or partially overlapping said carrier rings and is inside the movement path of said container receivers.

7. The container handling arrangement according to claim 6, wherein:
said at least one lifting element comprises a lifting drive; and
said lifting drive comprises a threaded spindle drive, a motorized lifting drive, a motorized linear drive, or a motorized spindle drive.

8. The container handling arrangement according to claim 7, wherein said contact elements comprise elongated, strip-like contact elements that are disposed such that their longitudinal extension is parallel or essentially parallel to the vertical axis of rotation.

9. The container handling arrangement according to claim 8, wherein:
said first carrier ring comprises a curved or rounded first projection at which said first connecting arrangement is operatively connected;
said first connecting arrangement is oriented tangentially or essentially tangentially to said first projection, or parallel or essentially parallel to a tangent of said first projection;
said second carrier ring comprises a curved or rounded second projection at which said second connecting arrangement is operatively connected; and
said second connecting arrangement is oriented tangentially or essentially tangentially to said second projection, or parallel or essentially parallel to a tangent of said second projection.

10. The container handling arrangement according to claim 9, wherein:
said transport element comprises a base support;
said container handling arrangement comprises a plurality of guides or guide elements connected to said base support; and
said guides or guide elements are configured and disposed to support and hold said carrier rings, and are configured to permit rotation of said carrier rings.

11. The container handling arrangement according to claim 10, wherein:
said first rod of said first connecting arrangement lies in a first plane perpendicular to the surface of said first carrier ring;
said second rod of said second connecting arrangement lies in a second plane perpendicular to the surface of said first carrier ring;
the first and second planes, and thus the first and second rods lying therein, together define an angle that is open towards the vertical axis of rotation, and which angle is one of (A) and (B):
(A) less than 45 degrees; and
(B) less than 180 degrees.

12. The container handling arrangement according to claim 11, wherein the vertical plane defined by said adjustment axis and said vertical axis of rotation is a plane of symmetry, and said first and second connecting arrangements are arranged mirror-symmetrically with respect to the plane of symmetry.

13. The container handling arrangement according to claim 1, wherein said lifting element is disposed offset from and not coaxial with said vertical axis of rotation.

14. The container handling arrangement according to claim 13, wherein said lifting element is disposed above a portion of said first carrier ring adjacent an outer edge of said carrier ring.

15. The container handling arrangement according to claim 1, wherein:
said first connecting arrangement comprises a first rod, a first end portion operatively connected to said first carrier ring, and a second end portion operatively connected to said lifting element;
said first end portion of said first connecting arrangement comprises a ball joint;
said second connecting arrangement comprises a second rod, a first end portion operatively connected to said second carrier ring, and a second end portion operatively connected to said lifting element; and
said first end portion of said second connecting arrangement comprises a ball joint.

16. The container handling arrangement according to claim 15, wherein said lifting element is configured to be adjusted to move said first end portions of said first and second connecting arrangements along a rounded or circular path, and thereby move said first and second carrier rings.

17. The container handling arrangement according to claim 16, wherein said lifting element is configured to be adjusted to move said first end portions closer to and further away from said lifting element along the rounded or circular path.

18. The container handling arrangement according to claim 15, wherein:
each of said first and second carrier rings comprises a projection disposed to project inwardly beyond the inner diameter of each of said first and second carrier rings; and
said first and second connecting arrangements are operatively connected to said first and second carrier rings at said projections.

19. The container handling arrangement according to claim 18, wherein each of said first end portions is disposed above a corresponding one of said projections, and is connected thereto by a substantially vertically-oriented elongated connecting structure.

20. The container handling arrangement according to claim 1, wherein said contact elements comprise elongated, strip-like contact elements that are disposed such that their longitudinal extension is parallel or essentially parallel to the vertical axis of rotation.
